(19) United States
(12) Patent Application Publication
(10) Pub. No.: US 2025/0310783 A1
(43) Pub. Date: Oct. 2, 2025

(54) SYSTEM(S) AND/OR METHOD(S) FOR FORECASTING USING GENERATED SYNTHETIC DATA

(71) Applicant: Verizon Patent and Licensing Inc., Basking Ridge, NJ (US)

(72) Inventors: Hector A Garcia Crespo, North Richland Hills, TX (US); Timothy E Coyle, Chicopee, MA (US); Jason A Birr, Lithia, FL (US); Ammara Essa, Los Angeles, CA (US)

(21) Appl. No.: 18/616,982

(22) Filed: Mar. 26, 2024

(51) Int. Cl. H04W 16/22; H04W 24/06

(52) U.S. Cl. CPC H04W 16/22; H04W 24/06

(57) ABSTRACT

One or more methods and/or systems for generating synthetic data are provided. Profiles are generated for wireless communication sites from first data gathered for a first time period. Measures of similarity of second wireless communication sites to a first wireless communication site are calculated based on the generated profiles. Second wireless communication sites are selected based upon the measures of similarity. Weightings are generated for the selected second wireless communication sites based upon the measures of similarity of the selected second wireless communication sites. Second data is gathered for a second time period from the selected second wireless communication sites. Synthetic data is generated based upon the gathered second data and the generated weightings for the selected second wireless communication sites. The generated synthetic data is for the first wireless communication site for the first time period.

### BACKGROUND

Wireless communication services, such as cellular services, wireless internet services, etc. may be used by organizations, companies, universities and other entities to interconnect people, machines, vehicles, sensors and other devices.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an example environment in which at least a portion of the techniques presented herein may be utilized and/or implemented, wherein the environment includes wireless communication sites, user equipment, a network, and a data generation system;

FIG. 2 is a schematic illustration of an instance of the environment of FIG. 1 showing a first wireless communication site and a plurality of second wireless communication sites;

FIG. 3 is a schematic illustration of an instance of the environment of FIG. 1 showing the first wireless communication site and five second wireless communication sites that are most similar to the first wireless communication site;

FIG. 4A is a flow chart illustrating a first part of an example method for generating synthetic data in accordance with an embodiment;

FIG. 4B is a flow chart illustrating a second part of the example method for generating synthetic data in accordance with the embodiment;

FIG. 5 is a flow chart illustrating at least some of the example method shown in FIG. 4B;

FIG. 6 is a plot of data collected for a first time period for a first wireless communication site, wherein the plotted data has a general shape, which is shown overlaying the plotted data;

FIG. 7 shows a collection of shapes that may be used with the general shape of the plotted data shown in FIG. 6 to generate a plurality of shape correlation values, which may be used for generating a behavior shape profile for a wireless communication site;

FIG. 8 is a table containing data calculated for the five most similar second wireless communication sites shown in FIG. 3 pursuant to at least some of the example method(s) shown in FIGS. 4A, 5;

FIG. 9 is a plot of synthetic data history for the first wireless communication site for an extended time period that includes the first time period and a second time period, wherein the data for the second time period is generated synthetic data;

FIG. 10 is an illustration of a scenario featuring an example non-transitory machine readable medium in accordance with one or more of the provisions set forth herein; and

FIG. 11 is an example environment in which systems and/or methods described herein may be implemented.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The methods herein may be performed by or in conjunction with the foregoing.

The following provides a discussion of some types of scenarios in which the disclosed subject matter may be utilized and/or implemented.

The present disclosure relates to an environment having wireless communication sites (or simply “sites”) that send and receive wireless radio transmissions to and from end user devices, e.g., user equipment (UE). UEs may be mobile or fixed. Each wireless communication site may include a base station that controls low-level operation of a plurality of UEs wirelessly connected to the base station. One or more base stations may be part of a radio access network (RAN), which may be connected to a core network operated by a telecommunication service provider. The core network may be connected to an external network, such as the Internet and/or cloud services. The telecommunication network may extend throughout a nation or a certain geographical area, thus there may be a multitude of network devices, virtual devices and the like with various configurations, parameters and measurements associated therewith that can determine performance of the network.

It is important to have historical data in order to effectively monitor and optimize RAN performance in a network, such as that generally described above. It is also important for making forecasts for the network and/or its expansion. The need for historical data is particularly important when machine learning applications are used for monitoring, optimizing and/or forecasting. However, when new sites are added, there is little to no historical data for the new sites, i.e., they are data-deficient sites. In addition, due to data volume and upstream system outages, key performance indicator (KPI) data for a particular subset of a RAN may also be lost for extended periods of time.

Generated synthetic data may be used as a substitute or replacement for missing or lost data for a wireless communication site, thereby enabling complex optimization applications and forecasts to be performed. In accordance with some embodiments of the present disclosure, a data generation system is provided for performing methods of generating synthetic data for wireless communication sites that are data-deficient. This generated synthetic data may be used to permit and/or enhance the use of optimization applications and forecasts.

As part of a method, the data generation system may gather data from a data-deficient wireless communication site with limited or missing historical data and other, data-rich wireless communication sites with ample historical data, all of which may be in the network. In this regard, data-rich sites are generally sites that either have more historical data (or the relevant historical data needed to generate synthetic data) than a data-deficient site, or have existing historical data for a time gap for which data is missing and needs to be filled for a data-deficient site. The data that is gathered by the data generation system may include KPIs, as well as the network element characteristics of the sites. The data generation system uses the gathered data to generate synthetic data for the data-deficient site. The generated synthetic data may be used to fill in missing data and/or create a synthetic data history for the data deficient site.

The generated synthetic data and the data gathered from the wireless communication sites may be time series data comprising a sequence taken at successive equally spaced points in time (e.g., hourly, daily. weekly, etc.). In other words, a sequence of discrete-time data.

In one or more of the methods disclosed herein, a plurality of data-rich wireless communication sites may be selected that are most similar to a data-deficient wireless communication site. Weightings may be generated for the selected data-rich wireless communication sites based upon a similarity of the selected data-rich wireless communication sites to the data-deficient wireless communication site. Data for a second time period may be gathered from the selected data-rich wireless communication sites. Synthetic data may be generated based upon the data gathered from the selected data-rich wireless communication sites for the second time period and the generated weightings for the selected data-rich wireless communication sites. The generated synthetic data may be for the data-deficient wireless communication site for the second time period.

Also, in one or more of the methods disclosed herein, first data may be gathered from wireless communication sites for a first time period. Profiles may be generated for the wireless communication sites from the gathered first data. Measures of similarity of data-rich wireless communication sites to a data-deficient wireless communication site, respectively, may be calculated based upon the generated profiles. Data-rich wireless communication sites may be selected based upon the measures of similarity. Weightings for the selected data-rich wireless communication sites may be generated based upon the measures of similarity of the selected data-rich wireless communication sites. Second data for a second time period may be gathered from the selected data-rich wireless communication sites. Synthetic data may be generated based upon the gathered second data and the generated weightings for the selected data-rich wireless communication sites. The generated synthetic data may be for the data-deficient wireless communication site for the second time period.

In a first scenario, generated synthetic data may be used to supplement limited historical data of the data-deficient wireless communication site. The data-deficient wireless communication site may be a new site that has been in operation for a limited first time period and for which only a limited amount of historical data has been gathered and stored. This limited amount of historical data may be less than a desired amount of historical data. The data generation system may use gathered historical data of the other, data-rich wireless communication sites to generate synthetic data for the data-deficient site that is for a second time period immediately preceding (temporally) the first time period. This generated synthetic data may be combined with the limited amount of historical data to create a synthetic history having an amount of historical data that meets or exceeds the desired amount of historical data. In a more specific example of the foregoing first scenario, the data-deficient site may be a newly added site with only 3 months of historical data and the data-rich sites may be sites with more than one year of historical data including the 3 months existing for the data-deficient site.

In a second scenario, the generated synthetic data may be used to replace data for the data-deficient wireless communication site that has been lost. For example, the data-deficient wireless communication site may be an established site that has been in operation for a longer period of time and for which historical data has been gathered and stored. However, some of this historical data may be missing for one or more time periods (“missing time periods”). The data may be missing due to data corruption, equipment damage or some other reason. The data generation system may use gathered historical data of the other, data-rich wireless communication sites to generate synthetic data for the data-deficient wireless communication site that is for the missing time period(s). This generated synthetic data may be used to fill in the missing portion(s) of the gathered historical data for the data-deficient wireless communication site to create a restored (complete) synthetic history for the data-deficient wireless communication site. In a more specific example of the foregoing second scenario, the data-deficient site may have a missing data gap of 2 months (but has data before and after the gap that can be used to profile), and the data-rich sites may have existing historical data for the 2 months for which the data-deficient site is missing data, including historical data before and after the gap.

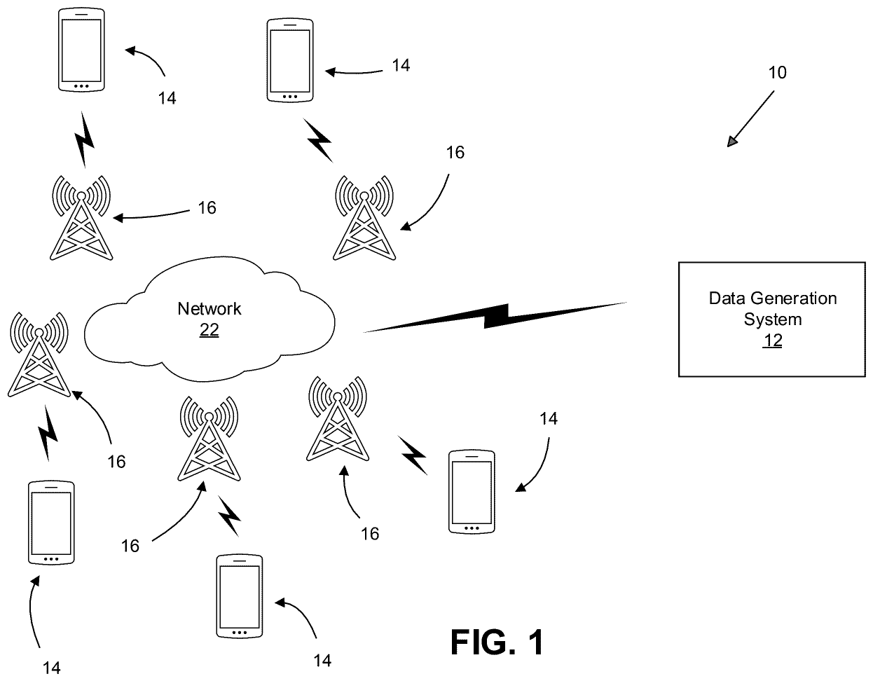

FIG. 1 is a diagram of an example environment 10 in which systems and/or methods described herein may be implemented. As illustrated, environment 10 may include a data generation system 12 and user equipment (UE) 14 associated with wireless communication sites 16. The wireless communication sites 16 may be part of one or more RANs which may be connected to a core network, which, in turn, may be connected to an external network, such as the Internet and cloud services. Devices/networks of environment 10 may be interconnected via wired connections, wireless connections, or a combination of wired and wireless connections. These connections may be collectively referred to as network 22.

Components of environment 10 may have a Universal Mobile

Telecommunications System (UMTS) or third generation (3G) architecture, a long-term evolution (LTE) or fourth generation (4G) architecture, a new radio (NR) or fifth generation (5G) architecture, or a combination of the foregoing.

Each UE 14 may comprise a mobile phone, a laptop computer, a tablet computer, a desktop computer, or other type of wireless communication device. Each UE 14 may include a transceiver circuit operable to transmit/receive signals to/from a connected wireless communication site 16 via one or more antenna. Each UE 14 may further include a user interface, memory and a controller. The controller in each UE 14 controls the operation of the UE 14 in accordance with software stored in memory.

Each wireless communication site 16 has a base station that includes transceiver circuitry operable to transmit/receive wireless signals to/from connected UEs 14 via one or more antenna. Each base station may also be operable to transmit/receive signals to/from other wireless communication sites 16 and/or a core network through one or more appropriate interfaces, such as a site-site interface and/or a site-core network interface. Signals may be transmitted/received to/from other wireless communication sites and/or a core network wirelessly or through hard connections, such as cable or fiber optic connections. One or more controllers may control the operation of each wireless communication site 16 in accordance with software stored in memory. A wireless communication site 16 may further include infrastructure such as a tower and one or more enclosures for housing equipment, such as computers, sensors, etc.

Depending on the architecture of the network component it is a part of, a wireless communication site 16 may be a Node B site, an eNodeB (eNB) site, a gNodeB (gNB) site or another type of site that provides cellular communications. More specifically, if a network component has a 3G architecture, a wireless communication site 16 in the network component may be a Node B site; if a network component has a 4G architecture, a wireless communication site 16 in the network component may be an eNB site; and if a network component has a 5G architecture, a wireless communication site 16 in the network component may be an gNB site.

The data generation system 12 may include one or more personal computers, one or more workstation computers, one or more server devices, one or more virtual machines provided in a cloud computing environment, or one or more other types of computation and communication devices. The data generation system 12 may be installed in the environment 10 and may be in communication with all of the wireless communication sites 16 via the network 22. In some implementations, the data generation system 12 may be associated with an entity that manages and/or operates all or a portion of the environment 10, such as, for example a telecommunication service provider.

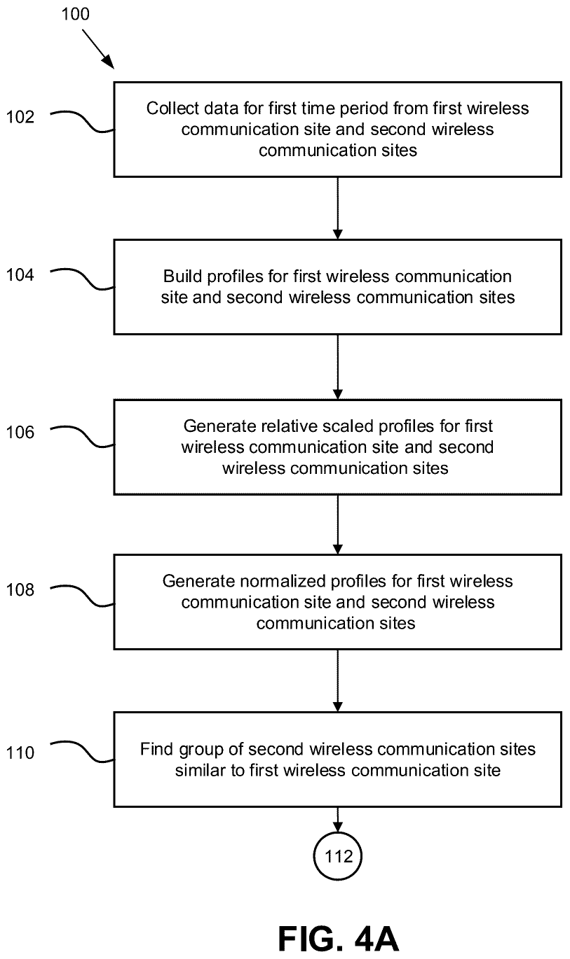

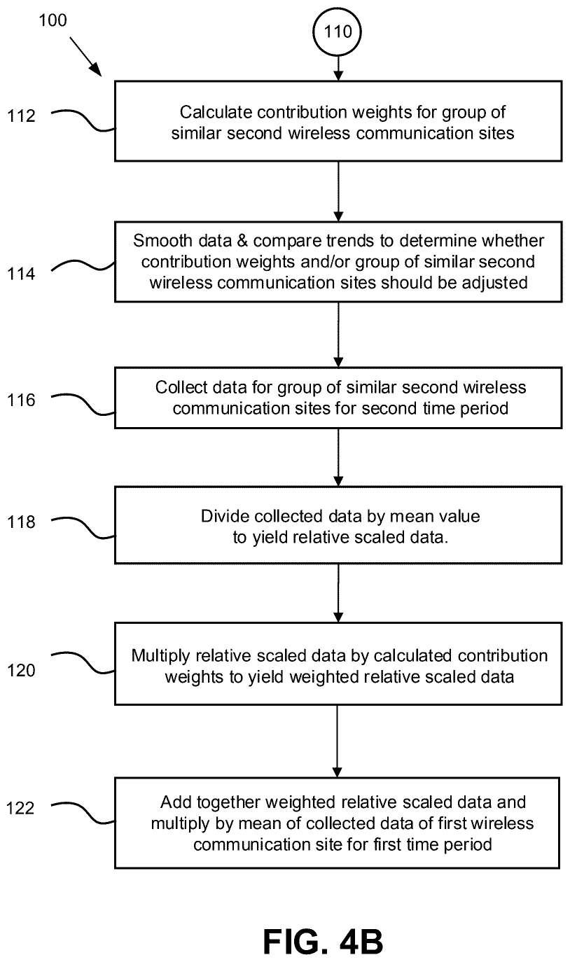

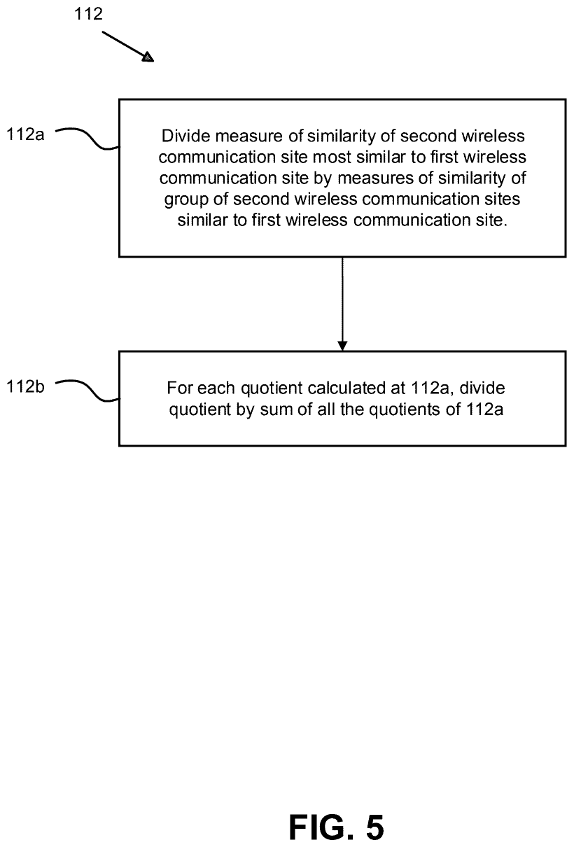

The data generation system 12 generally performs one or more methods for generating synthetic data. An example of such a method is shown in FIGS. 4A, 4B, 5 and is designated with the reference numeral 100. The method 100 may be a nonparametric regression algorithm. The method 100 is nonparametric because it does not make any assumptions about the characteristics of the wireless communication sites 16 or whether the gathered data is quantitative or qualitative. Instead, the method operates on the principle of similarity of data.

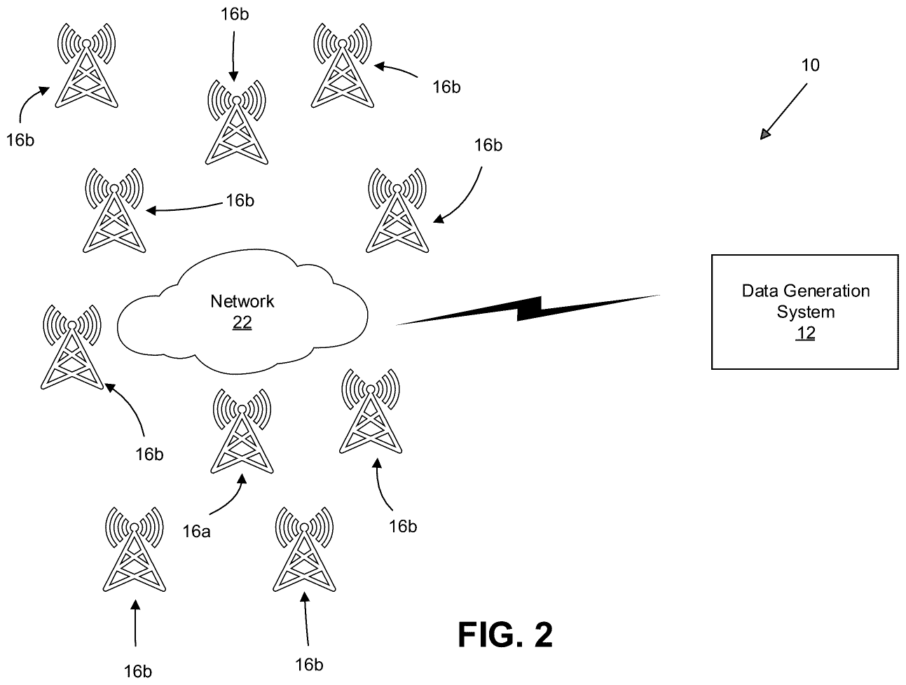

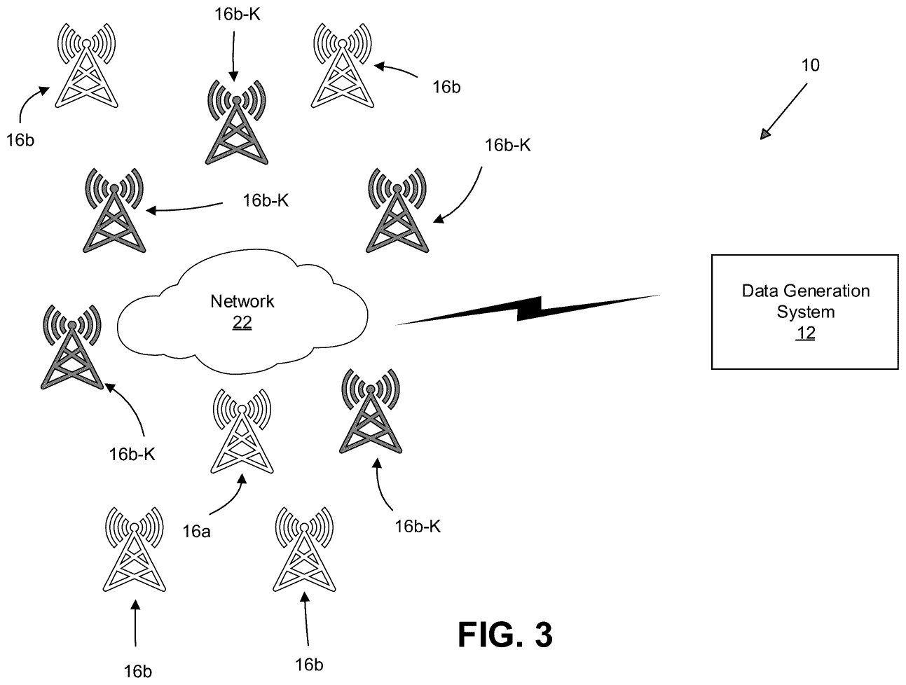

Referring now to FIGS. 2 and 3, there are shown instances of the environment 10 for use in describing the method 100. In FIG. 2, the environment 10 includes a data-deficient or first wireless communication site 16a and a plurality of data-rich or second wireless communication sites 16b. In FIG. 3, the environment 10 further includes second wireless communication sites 16b-K. Although not shown, UEs 14 may be wirelessly connected to the first wireless communication site 16a and the second wireless communication sites 16b, including the second wireless communication site 16b-K.

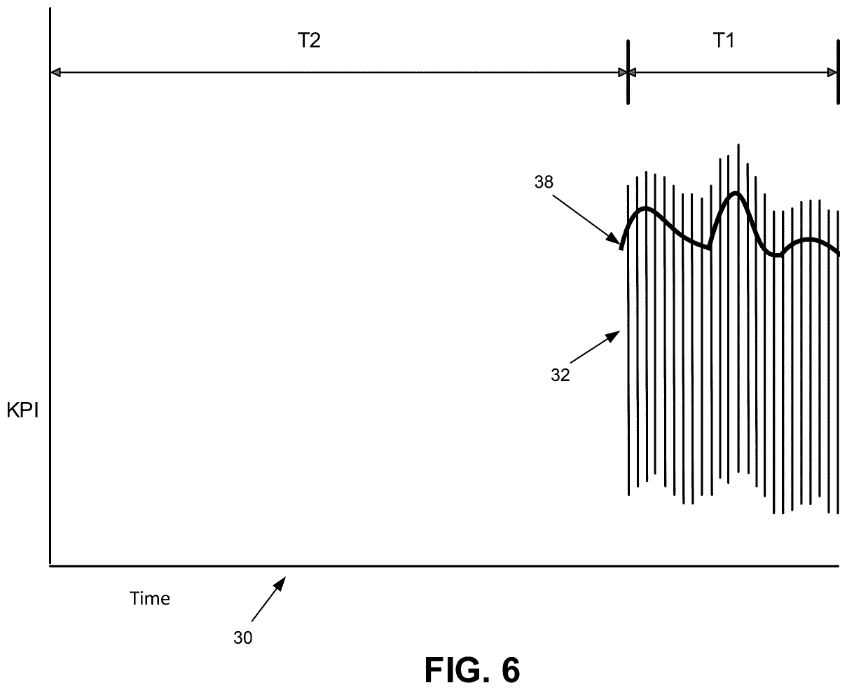

The method 100 will now be described with further reference to FIGS. 4A, 4B. At 102 of the method 100, the data generation system 12 gathers data for a training or first time period T1 (shown in FIG. 6) in which data is at least mostly available from the first wireless communication site 16a and a particular portion of the second wireless communication sites 16b in the environment 10. The selected portion of the second wireless communication sites 16b may be all of the second wireless communication sites 16b or a smaller portion, based on certain specified criteria. The data gathered at 102 may also be for one or more second time periods T2 (shown in FIG. 6), although data gathering for the second time period(s) may instead be performed otherwise, such as at 116, which is performed before 118. In a second time period T2, data from the first wireless communication site 16a may be missing (and for which synthetic data may be generated), but data from the particular portion of the second wireless communication sites 16b may be at least mostly available.

At 102, data may be gathered from a data repository that automatically collects and stores all historical data from the wireless communication sites 16. The stored historical data may be time series data taken on a daily or other basis.

The length of the first time period may be from two to six months or longer. In one implementation, the length of the first time period may be at least three months. The first time period may extend backward from the present time, e.g., is for the most recent time period, or may be for another time period.

A second time period may immediately or proximately precede (temporally) a most recent time period (which may also be the first time period), such as may be the case for a new first wireless communication site 16a with a limited data history. Alternately, a second time period may be located between available time periods in which data for the first wireless communication site 16a is available, such as may be the case for data that has been lost or destroyed. The length of a second time period may be for as long as needed or desired, subject to the availability of data. When the second time period is between available time periods, the length of the second time period may be the same or substantially the same as the length between the available time periods. When the second time period immediately or proximately precedes a most recent time period, the second time period may extend for as long as desired and for which data from all or a substantial portion of the wireless communication sites 16b is available. In some instances, such a second time period may be more than one year or more.

The first wireless communication site 16a and some of the selected portion of second wireless communication sites 16b may be missing minor amounts (e.g. one or two days' worth) of data for the first time period. Some of the selected portion of second wireless communication sites 16b may also be missing minor amounts of data for the second time period. The minor amounts of missing data may be replaced with data such as by front filling, back filling, mean filling, distribution random filling or normal distribution filling. This data filling may be performed before 104 below is performed.

Instead of performing data filling for those second wireless communication sites 16b missing minor amounts data, these second wireless communication sites 16b may simply be removed from the particular portion of second wireless communication sites 16b whose data is used at 104.

The gathered data for the first time period T1 is used to perform 104, which builds profiles for the first wireless communication site 16a and some or all of the second wireless communication sites 16b. 104 may include building a statistical profile, a site profile and a behavior shape profile for each wireless communication site 16. Other profiles may be used as well.

The data gathered may be a KPI, such as average active connections, e.g., average number of users (UEs 14) connected per hour in a day or other time basis (AvgAC). Other KPIs that may be used include (on a relevant time or other basis): data rate or throughputs; spectrum efficiency or utilization; number of handovers (e.g., handovers of moving UEs from one wireless communication site 16 to another); percentage of time the site is operational; number of failures or outages; signal strengths; voice quality or clarity; data latency or delay; and packet loss or error rate. Of course, the foregoing list is not exhaustive and other KPIs may be used as well.

As part of 104, a statistical profile for each wireless communication site 16 may be built. The statistical profile may include for the specified time period (e.g. a three-month time period): a mean value, standard deviation, minimum, maximum, 90^{th} percentile, 80^{th} percentile, 50^{th} percentile, 20^{th} and/or other percentiles. In addition, for each day of the week (Sunday-Saturday) in the specified time period, a mean value and standard deviation may be calculated. The foregoing statistical profile construction is provided as an example and is not limiting. Other statistical profile constructions may be used.

Also, as part of 104, a site profile for each wireless communication site 16 may be built. The site profile may include its morphology, site type and band of frequencies. The morphology may be a classification (represented by a number). The morphology classes may generally include rural, suburban, urban and dense urban, with different numbers associated with each class. Additional morphology classifications may be used, which are based on the foregoing general classifications, but are narrowed by additional factors, such as topography, housing density, tree density and multi-story building density, etc. The foregoing morphology classes are provided as an example and are not limiting. Additional and/or different morphology classes may be used.

The site type may be a classification (represented by a number). The site type classes may generally include: tower, small-scale, rooftop, indoor, mobile, and distributed antenna system (DAS), which may be indoor or outdoor. The foregoing site type classes are provided as an example and are not limiting. Additional and/or different site type classes may be used.

The band of frequencies may be a classification (represented by a number). The band classes may generally include classes for 2G bands, 3G bands, 4G bands and/or 5G bands. Examples of classes for 2G bands may include GSM 850 and GSM 1900; examples of classes for 3G bands include UMTS 850, UMTS 1900, UMTS 1700 and UMTS 2100; examples pf classes for 4G bands include LTE 700 (bands 12, 13, 17), LTE 1700 (bands 4, 66), LTE 1900 (bands 2, 25) and LTE WCS 2300 (30); and examples pf classes for 5G bands include 5G 2500 (band 41), 5G 39 (band 260), 5G 28 (band 260) and 5G 600 (band 71). The foregoing bands are provided as an example and are not limiting. Additional and/or different bands may be included.

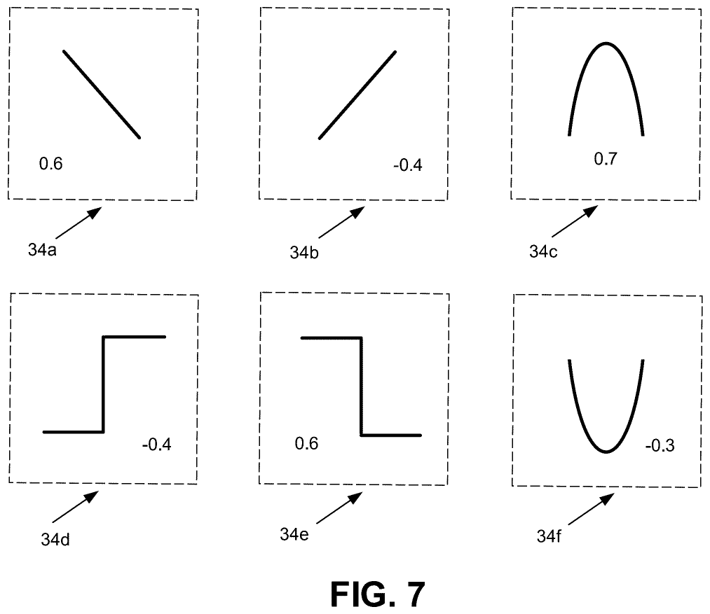

Further as part of 104, a behavior shape profile may be generated for each wireless communication site 16. The behavior shape profile may include one or more shape correlation values relating to the shape of a plot of KPI value versus time (in days or otherwise) over the specified period of time. Such a plot is shown in FIG. 6 and is designated by reference numeral 30. A shape correlation value provides an indication of the similarity of a simple shape to the plot shape. A set of predetermined simple shapes may be used to generate a plurality of shape correlation values. Such a shape set may, by way of example, include the shapes 34a-f shown in FIG. 7. Shape 34a is a downwardly sloping line; shape 34b is an upwardly sloping line; shape 34c is a convex curve; shape 34d is an upward step; shape 34e is a downward step; and shape 34f is a concave curve. The similarity of the simple shapes 34a-f to a plot shape (e.g., the shape correlation values) may be represented by positive or negative fractional numbers in a range of [−1, 1]. The greater (more positive) a shape correlation value is, the more similar the simple shape is to the plot shape. For example, in FIG. 6, the plot 30 shows plotted data 32 for the first wireless communication site 16a for the first time period T1. The plotted data 32 may have a plot shape 38 with a wavy configuration having three concave curves that slopes downwardly overall. The shapes 34a-f are determined to have shape correlation values of: 0.6, −0.4, 0.7, −0.4, 0.6 and −0.3, which indicates that shape 34c is most similar to the plot shape 38, while shapes 34b and 34d are the least similar to the plot shape 38.

The shape correlation values may be generated/calculated by a software routine stored in memory and executed by a processor of the data generation system 12. In some embodiments, the routine may use human input through a use interface of the data generation system 12 to help teach the routine to generate the shape correlation values.

At 106 of the method 100, the statistical profile for each site 16 generated at 104 may be divided by its mean value for the specified time period so as to bring the statistical profile to a relative scale, e.g., to generate a relative scaled profile. Thus, by way of example, if the gathered data is AvgAC, dividing the statistical profile for each site 16 by its mean value for the specified time period (e.g. 3 months) gives a statistical measure relative to each site's mean load. This statistical measure allows behaviors for higher loaded sites 16 to find similar statistical relationships with less loaded sites 16 regardless of their raw user load difference.

Depending on the nature of the data gathered, normalization of the output from 106 may be performed at 108. Normalization may be used to avoid similarity metrics being skewed by relatively larger feature values. For example, in the routine of 110 below, a Euclidian distance may be used, wherein a large mean value could skew the distance and find similarities mainly based on the mean value. Several different normalizations may be used. In some instances, min-max normalization may be used, wherein a formula for min−max of [0,1] is given as:

$${x}^{′} = \frac{x - min ( x )}{max ( x ) - min ( x )}$$

where x is an original value, x′ is the normalized value, max(x) is a maximum of x and min(x) is a minimum of x.

In other instances, a mean normalization may be used, wherein a formula for mean normalization is given as:

$${x}^{′} = \frac{x - \overline{x}}{max ( x ) - min ( x )}$$

where x is an original value, x′ is the normalized value, x̅ is the mean of x, max(x) is a maximum of x and min(x) is a minimum of x.

In other instances, a Z-score normalization may be used, wherein a formula for Z-score normalization is given as:

$${x}^{′} = \frac{x - \overline{x}}{{σ}_{x}}$$

where x is an original value, x′ is the normalized value, x̅ is the mean of x and σₓ is the standard deviation of x.

At 110, a similarity search routine may be used to find a certain number of second wireless communication sites 16b that are most similar to a first wireless communication site 16a based on the profiles generated at 104 (e.g., statistical, site and shape), or the normalized profiles from 106 or 108. One of the similarity search routines that may be used is a K-nearest neighbor type of search routine. The similarity search routine is nonparametric and operates on the principle of similarity, as represented by calculated distances of the second wireless communication sites 16b from the first wireless communication site 16a, wherein the shorter the distance is between a second wireless communication site 16b and a first wireless communication site 16a, the more similar the second wireless communication site 16b is considered to be to the first wireless communication site 16a. Each distance for a second wireless communication site 16b is calculated from differences between profile values of the first wireless communication site 16a and corresponding profile values of the second wireless communication site 16b. The distance may be: a Euclidian distance, where each difference in corresponding profile values is squared, the squared differences are added together and then the square root of the sum is taken; a Manhattan distance where the absolute value is taken of each difference in corresponding profile values and the absolute values of the differences are added together; a Minkowski distance where the absolute value is taken of each difference in corresponding profile values and then raised to the power of p, the absolute values of the differences taken to the power of p are added together and then the pth root of the sum is taken; or another type of distance.

In some instances, a Euclidian distance (X, Y) from a second wireless communication site X to a first wireless communication site Y may be used and is calculated using:

$$distance ( X , Y ) = \sqrt{{\sum }_{i = 1}^{n} {( {x}_{i} - {y}_{i} )}^{2}}$$

where the second wireless communication site X has profile values Xᵢ through Xₙ and the first wireless communication site Y has corresponding profile values Yᵢ through Yₙ.

In some instances, a Manhattan distance (X, Y) from a second wireless communication site X to a first wireless communication site Y may be used and is calculated using:

$$distance ( X , Y ) = {\sum }_{i = 1}^{n} \vert {x}_{i} - {y}_{i} \vert$$

where the second wireless communication site X has profile values Xᵢ through Xₙ and the first wireless communication site Y has corresponding profile values Yᵢ through Yₙ.

In some instances, a Minkowski distance (X, Y) from a second wireless communication site X to a first wireless communication site Y may be used and is calculated using:

$$distance ( X , Y ) = {( {\sum }_{i = 1}^{n} {\vert {x}_{i} - {y}_{i} \vert}^{p} )}^{\frac{1}{p}}$$

where the second wireless communication site X has profile values Xᵢ through Xₙ and the first wireless communication site Y has corresponding profile values Yᵢ through Yₙ.

The distances from a first wireless communication site 16a to all or some of the wireless communication sites 16b in the environment 10 are generated and may then be sorted, such as from shortest to longest. The K shortest distances may then be selected to thereby yield the K most similar second wireless communication sites 16b to the first wireless communication site 16a, e.g., similar sites 16b-K.

The selection of the integer value of K may be chosen based on the gathered data. If the value of K is too small, the similarity search may be overly sensitive to noise in the data. However, if K is too large, the similarity search algorithm may oversimplify and fail to capture important patterns in the data. In addition, a large K value requires more computational resources. In some instances, an integer value in the range of from five (5) to ten (10) may be used for K. In some instances, smaller K values (such as 5) may be used for larger first sites 16, e.g., first sites 16 having larger AvgAC values, while larger K values (such as 10) may be used for smaller first sites 16, e.g., first sites 16 having smaller AvgAC values. In order to avoid ties, K may be an odd number.

Cross-validation methods may be used to select the value of K. In a cross-validation method, data is split into training and testing sets multiple times and the similarity search algorithm's performance is evaluated for different values of K. This permits a value of K to be chosen that results in the best overall performance on the data.

Once the similar sites 16b-K have been found at 110, contribution weights for these similar sites 16b-K may be calculated at 112. With reference now to FIG. 5, 112 is shown as comprising 112a, 112b, 112c. At 112a, the distances for the similar sites 16b-K are divided by the smallest of the distances. At 112b, the inverses of the quotients of 112a are calculated. At 112c, each inverse calculated in 112b is divided by the sum of all the inverses calculated in 112b, thereby yielding the contribution weights for the similar sites 16b-K.

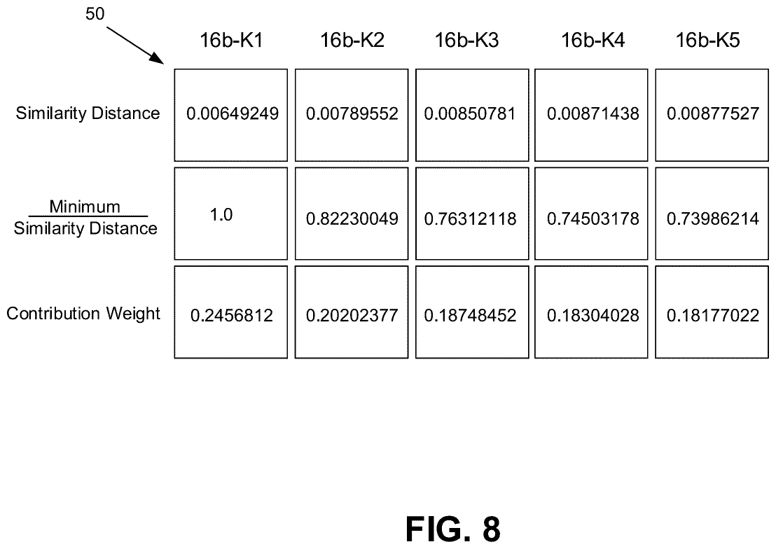

In the instance shown in FIG. 3 referenced above, K=5 and the similarity search routine has found the five most similar second wireless communication sites 16b to the first wireless communication site 16a. These similar sites may be more specifically designated by the reference numerals 16b-K1, 16b-K2, 16b-K3, 16b-K4 and 16b-K5, as shown in FIG. 8. The distances of the similar sites 16b-K1, 16b-K2, 16b-K3, 16b-K4, 16b-K5 to the first wireless communication site 16a are shown in row one of the table 50 in FIG. 8. At 112a, the minimum of the distances (0.00649249) is divided by the distances to yield the values shown in row two of the table 50. At 112b, the quotients calculated in 112a are added together to yield 4.07031559, which is then used to divide each of the quotients to yield the contribution weights shown in row three of the table 50, namely 0.2456812, 0.20202377, 0.18748452, 0.18304028 and 0.18177022.

At 114, the data for the first time period T1 for the first wireless communication site 16a and the similar sites 16b-K may be smoothed to help reveal their trends. The data smoothing may be performed using a smoothing algorithm, such as the moving average of the last “n” samples or the rectangular smooth or the triangular smooth. The smoothed data of the similar sites 16b-K may then be compared to the smoothed data of the first wireless communication site 16a to determine whether the data of the similar sites 16b-K have the same trends as the data of the first wireless communication site 16a. If the trend of a particular similar site 16b-K is not the same as that of the first wireless communication site 16a, the particular similar site 16b-K may be removed from the calculation of the contribution weights at 112, e.g., 112 may be re-performed without the data from the particular similar site 16b-K. Alternately, the profiles of the particular similar site 16b-K may be removed from the performance of the similarity search algorithm at 110, e.g., 110 may be re-performed without the profiles of the particular similar site 16b-K and then 112, 114 may re-performed. The data smoothing may be performed by a trend analysis algorithm or may be visually determined by a human viewing graphs of the smoothed data on a user interface of the data generation system 12.

In some instances, 114 may not be performed. In other instances, 114 may be performed before 112 so that adjustment(s) to the similar sites 16b-K and/or the calculation of the contribution weights is/are performed before the contribution weights are initially calculated.

If the data for the second time period T2 has not already been gathered at 102, the data generation system 12 gathers data for the similar sites 16b-K for the second time period T2 at 116. At 116, data may be gathered from a data collection system (e.g., data collection system 322) that automatically collects and stores all historical data from the wireless communication sites 16 in a data repository (e.g., data repository 320).

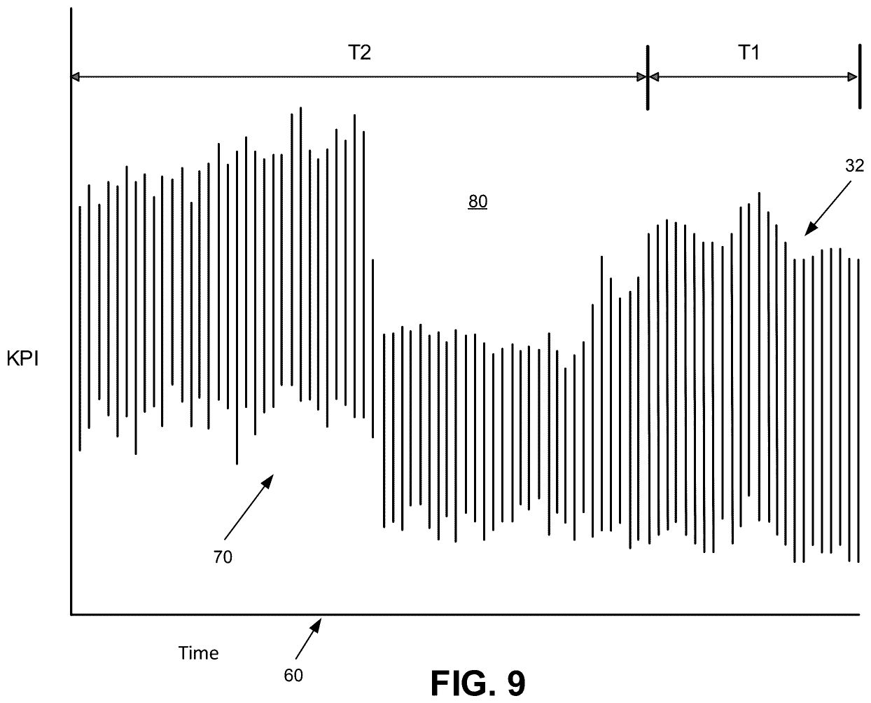

At 118-122, the contribution weights calculated at 112 are used to generate synthetic data 70 (shown in FIG. 9) for the first wireless communication site 16a for the second time period T2. At 118, mean values are calculated for data (such as AvgAC) gathered from the similar sites 16b-K found at 110 (for the second time period T2). The gathered data and mean values may be per day or other time increment. The data values for the similar sites 16b-K are divided by the mean values for the similar sites 16b-K, respectively, thereby yielding relative scaled data. At 120, the relative scaled data is multiplied by the contribution weights for the similar sites 16b-K, respectively, thereby yielding weighted relative scaled values. At 122, for each time increment (e.g., day), the weighted relative scaled values for the similar sites 16b-K are added together and then multiplied by the mean value of the data for the first wireless communication site 16a for the first time period T1, thereby yielding synthetic data 70 values for the first wireless communication site 16a for the second time period T2.

The synthetic data 70 generated for the second time period T2 may be added to the data 32 for the first time period T1 to create a synthetic data history 80 for the first wireless communication site 16a for an extended time period that includes the first and second time periods T1, T2. A plot 60 of the synthetic data history 80 is shown in FIG. 9.

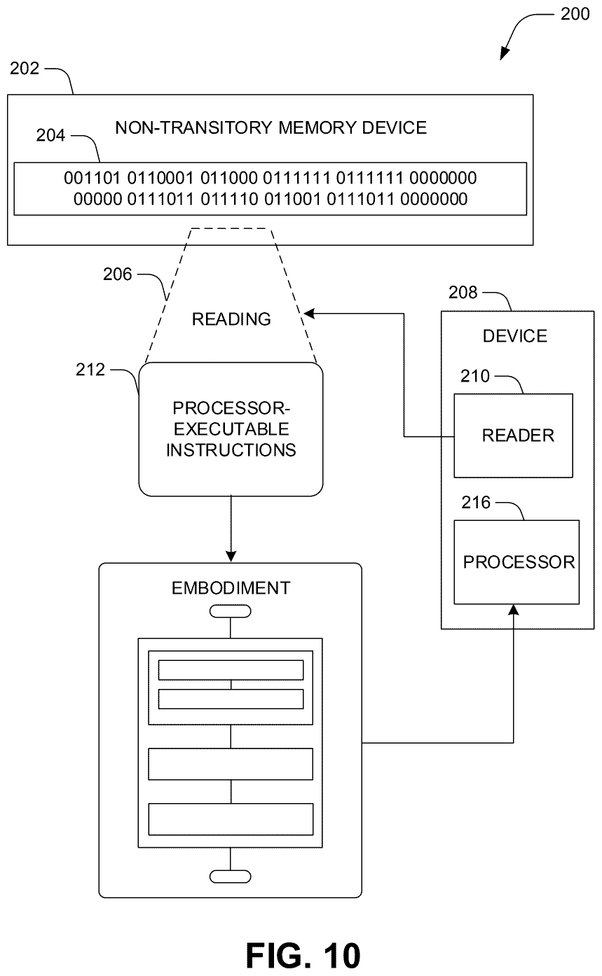

FIG. 10 is an illustration of a scenario 200 involving an example non-transitory machine readable medium 202. The non-transitory machine readable medium 202 may comprise processor-executable instructions 212 that when executed by a processor 216 cause performance (e.g., by the processor 216) of at least some of the provisions herein. The non-transitory machine readable medium 202 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 202 stores computer-readable data 204 that, when subjected to reading 206 by a reader 210 of a device 208 (e.g., a read head of a hard disk drive, or a read operation invoked on a solid-state storage device), express the processor-executable instructions 212. In some embodiments, the processor-executable instructions 212, when executed cause performance of operations, such as at least some of the example method 100 of FIGS. 4A, 4B, 5.

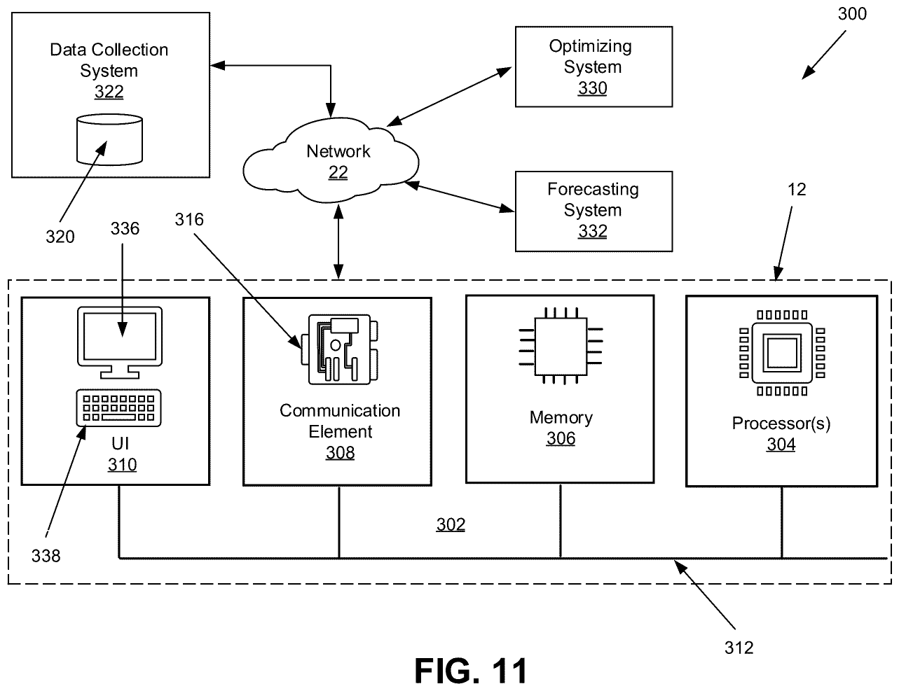

FIG. 11 shows an example environment 300 in which systems and/or methods described herein may be implemented. The environment 300 includes the data generation system 12, which may include a computing device 302 for performing all or a portion of the method 100. The computing device 302 may include one or more processors 304, memory 306, a communication element 308 and a user interface (UI) 310, all of which may be connected together by a bus 312. The processor(s) 304 may include multiple processors arranged into processing units, such as a central processing unit (CPU) and a graphics processing unit (GPU). The processor(s) 304 may execute instructions stored in a machine-readable, non-transitory medium, such as memory 306.

Memory 306 may include long-term memory, short-term memory, cache and/or a data storage unit. Memory 306 may store data, such as data gathered from wireless communication sites 16, and instructions, such as instructions for performing all or a portion of the method 100.

The communication element 308 enables the computing device 302 to communicate with other devices through a wired connection, a fiber optic connection and/or a wireless connection. For example, the communication element 308 may include a wireless transceiver, a fiber optic transceiver, a cable transceiver and a network interface 316. The communication element 308 may further include an antenna.

Using the communication element 308 (e.g., network interface 316), the computing device 302 may access data stored in a data repository 320 of a data collection system 322 connected to the network 22. The data collection system 322 may automatically collect and store all historical data from the wireless communication sites 16. Optimizing and forecasting systems 330, 332 may also be connected to the network 22 to receive generated synthetic data from the computing device 302 through the communication element 308. Such generated synthetic data may include the synthetic data 70 and/or the synthetic data history 80.

The optimizing system 300 may, by way of example, use generated synthetic data (together with actual historical data) to optimize a wireless communication site 16 or a network, such as by optimizing the radio frequency (RF) coverage footprints of one or more of the wireless communication sites 16 to minimize interference while assuring enough overlap for handovers. Such optimization or “RF shaping” may involve physical configuration changes to one or more wireless communication sites 16, such as by changing RF power and the azimuth and elevation of antennas.

The forecasting system 332 may, by way of example, use generated synthetic data (together with actual historical data) to help forecast future traffic patterns using one or more methods such one or more of the Holt-Winters, seasonal auto-regressive integrated moving average (SARIMA), long short-term memory (LSTM), gated recurrent unit (GRU) and convolutional neural network (CNN) methods. Such forecasting permits the deployment and modification of infrastructure in a timely and cost-effective manner.

The user interface 310 enables the computing device 302 to receive input from a user and to provide output to a user. For example, the user interface 310 may include a display screen 336 upon which a user may view a data plot, such as plots 30, 60 described above, as well as the standard shapes 34 for generating shape correlation values. The user interface 310 may further include a keyboard 338, keypad, touch screen and/or a microphone to input information from a user.

In another example environment (not shown), the computing device 302 may be used in a cloud computing system within which the data generation system 12 may execute. The cloud computing system may, in addition to the computing device 302, may include a resource management component and a host operating system (OS). The cloud computing system may, by way of example, execute on an Amazon Web Services platform, a Microsoft Azure platform or a Google Cloud Platform. The resource management component may perform virtualization of the computing device 302 to create a plurality of virtual computing systems, thereby permitting the computing device 302 to operate more efficiently, with lower power consumption, higher reliability, higher utilization and greater flexibility.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method performed by a computing device, the method comprising:
selecting a plurality of second wireless communication sites that are most similar to a first wireless communication site;
generating weightings for the plurality of second wireless communication sites based upon a similarity of the plurality of second wireless communication sites to the first wireless communication site;
gathering data for a second time period from the plurality of second wireless communication sites; and
generating synthetic data based upon the data gathered from the plurality of second wireless communication sites for the second time period and the weightings generated for the plurality of second wireless communication sites, the synthetic data being for the first wireless communication site for the second time period.

2. The method of claim 1, further comprising generating a synthetic data history for the first wireless communication site for an extended time period comprising the first time period and the second time period.

3. The method of claim 1, further comprising calculating measures of similarity of the plurality of second wireless communication sites to the first wireless communication site, and wherein generating the weightings comprises generating the weightings based on the measures of similarity of the plurality of second wireless communication sites.

4. The method of claim 3, further comprising:
gathering first data from wireless communication sites for the first time period; and
generating profiles for the wireless communication sites from the first data; and
wherein calculating the measures of similarity is based on the profiles.

5. The method of claim 4, wherein generating the profiles comprises generating statistical profiles for the wireless communication sites, and wherein a statistical profile for a wireless communication site comprises at least one of a mean value, a standard deviation, a minimum value, a maximum value, or a percentile value from the first data for the first time period for the wireless communication site.

6. The method of claim 4, wherein a measure of similarity, of the measures of similarity, for a second wireless communication site, of the plurality of second wireless communication sites, comprises a Euclidian distance calculation based upon profile values Xᵢ through Xₙ of the first wireless communication device and profile values Yᵢ through Yₙ of the second wireless communication site.

7. The method of claim 6, wherein selecting the plurality of second wireless communication sites comprises selecting K second wireless communication sites that have the K shortest Euclidian distances to the first wireless communication site, where K is an integer greater than 1.

8. The method of claim 7, wherein generating the weightings comprises generating weightings for the K second wireless communication sites by dividing the smallest of the Euclidian distances of the K second wireless communication sites by the K Euclidian distances to yield quotients, respectively, then dividing the quotients by the sum of all the quotients to yield the weightings for the K second wireless communication sites, respectively.

9. The method of claim 1, wherein the first time period is less than half the second time period.

10. A method performed by a computing device, the method comprising:
gathering first data from wireless communication sites for a first time period;
generating profiles for the wireless communication sites from the first data;
calculating, based upon the profiles, measures of similarity of second wireless communication sites to a first wireless communication site, respectively;
selecting a plurality of second wireless communication sites, from the second wireless communication sites, based upon the measures of similarity;
generating weightings for the plurality of second wireless communication sites;
gathering second data for a second time period from the plurality of second wireless communication sites; and
generating synthetic data based upon the second data and the weightings for the plurality of second wireless communication sites, the synthetic data being for the first wireless communication site for the second time period.

11. The method of claim 10, wherein generating the profiles comprises generating statistical profiles for the wireless communication sites, and wherein a statistical profile for a wireless communication site comprises at least one of a mean value, a standard deviation, a minimum value, a maximum value, or a percentile value from the first data for the first time period for the wireless communication site.

12. The method of claim 11, wherein generating the profiles comprises dividing the statistical profile of each wireless communication site by the mean value of each wireless communication site for the first time period to produce relatively scaled profiles of each wireless communication site.

13. The method of claim 12, wherein generating the profiles comprises performing min-max scaling of the relatively scaled profiles of the wireless communication sites.

14. The method of claim 10, wherein generating the profiles comprises generating site profiles for the wireless communication sites, and wherein a site profile for a wireless communication site comprises at least one of morphology, site type, or bands.

15. The method of claim 10, wherein generating the profiles comprises generating behavior shape profiles for the wireless communication sites, wherein a behavior shape profile for a wireless communication site comprises a shape correlation value, and wherein the shape correlation value provides an indication of similarity of a simple shape to a plot of data from the wireless communication site.

16. The method of claim 10, wherein a measure of similarity, of the measures of similarity, for a second wireless communication site, of the plurality of second wireless communication sites, comprises a distance calculated from a difference between a profile value of the first wireless communication site and a profile value of the second wireless communication site; and
wherein the distance is at least one of a Euclidian distance, a Manhattan distance, or a Minkowski distance.

17. The method of claim 16, wherein the Euclidian distance is calculated pursuant to:
$$distance ( X , Y ) = \sqrt{{\sum }_{i = 1}^{n} {( {x}_{i} - {y}_{i} )}^{2}}$$
where X represents the first wireless communication site and Y represents the second wireless communication site and where the first wireless communication site has profile values Xᵢ through Xₙ and the second wireless communication site has profile values Yᵢthrough Yₙ.

18. The method of claim 17, wherein selecting the plurality of second wireless communication sites comprises selecting K second wireless communication sites that have the K shortest Euclidian distances to the first wireless communication site, where K is an integer greater than 1.

19. The method of claim 18, wherein generating the weightings comprises generating weightings for the K second wireless communication sites by dividing the smallest of the Euclidian distances of the K second wireless communication sites by the K Euclidian distances to yield quotients, respectively, then dividing the quotients by the sum of all the quotients to yield the weightings for the K second wireless communication sites, respectively.

20. A computing device comprising:
one or more processors configured to execute instructions to perform operations comprising:
gathering first data from wireless communication sites for a first time period;
generating profiles for the wireless communication sites from the first data;
calculating, based upon the profiles, measures of similarity of second wireless communication sites to a first wireless communication site, respectively;
selecting a plurality of second wireless communication sites, from the second wireless communication sites, based upon the measures of similarity;
generating weightings for the plurality of second wireless communication sites;
gathering second data for a second time period from the plurality of second wireless communication sites; and
generating synthetic data based upon the second data and the weightings for the plurality of second wireless communication sites, the synthetic data being for the first wireless communication site for the second time period.
